(19) United States
(12) Patent Application Publication
(10) Pub. No.: US 2024/0151972 A1
(43) Pub. Date: May 9, 2024

(54) Near-Eye Light Field Augmented Reality Display

(71) Applicant: PetaRay Inc., New Taipei (TW)

(72) Inventors: Chao-Chien Wu, Taipei (TW); Jiun-Woei Huang, Taipei (TW); Hong-Ming Chen, Taipei (TW)

(21) Appl. No.: 18/227,088

(22) Filed: Jul. 27, 2023

(30) Foreign Application Priority Data
Nov. 9, 2022 (TW) 111142834

(51) Int. Cl. G02B 27/01; G02B 27/14; G06T 19/00

(52) U.S. Cl. CPC G02B 27/0172; G02B 27/14; G06T 19/006

(57) ABSTRACT

An augmented reality (AR) display is provided. The display comprises a light field generator and a birdbath eyepiece. The light field generator generates a light field as an output. The birdbath eyepiece connects to the light field generator for receiving and projecting the light field to human eye. The birdbath eyepiece comprises a beam splitter and a combiner. The combiner has a curved surface. Each beam of the light field is split into two beams by the beam splitter with one of the split beams reflected by the combiner. Three states-of-use of the birdbath eyepiece are provided for the near-eye light field AR display to transmit the light field to the human eye. A low f-number (or focal ratio) and a large eyebox are obtained to effectively expand the field of view and increase the volume of space within which the human eye can receive the light field.

### TECHNICAL FIELD OF THE INVENTION

The present invention relates to augmented reality (AR) display; more particularly, to providing a birdbath eyepiece for a wearable near-eye light field AR display, where three states-of-use of the birdbath eyepiece are provided.

### DESCRIPTION OF THE RELATED ARTS

With the advancement of technology, more devices and products have been developed for AR to enable the augmentation of real world with virtual objects. However, the near-eye AR displays in the market suffer from the vergence accommodation conflict (VAC) that causes discomforts like dizziness, nausea, etc. to users. The reason is that, when viewing an object, human eye adjusts its focal length, known as accommodation, based on the distance between the object and the observer. Simultaneously, the axes of both eyes converge on the same object, known as convergence. However, in the context of an AR display with a fixed imaging plane, the accommodation of the human eye remains fixed and cannot align with the convergence. This mismatch between accommodation and convergence leads to the occurrence of VAC. The VAC problem thus makes the user feel discomfort and even dizzy, especially when looking at a close-range virtual object. Hence, the prior arts cannot meet the actual visual comfort requirements of all users.

### SUMMARY OF THE INVENTION

The main purpose of the present invention is to provide a near-eye light field AR display, where three states-of-use of a birdbath eyepiece are provided to project a light field to human eye; and a low f-number (or focal ratio) and large eyebox are achieved to effectively expand the field of view (FOV) and increase the volume of space within which the human eye can move and still receive the light field.

To achieve the above purpose, the present invention is a near-eye light field AR display, comprising a light field generator and a birdbath eyepiece, where the light field generator generates a light field as an output; the birdbath eyepiece connects to the light field generator to receive the light field from the light field generator and project the light field to human eye; the birdbath eyepiece comprises a beam splitter and a combiner; and each beam of the light field is split into two beams by the beam splitter with one of the two beams reflected by the combiner. Accordingly, a novel near-eye light field AR display is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is a structural view showing a preferred embodiment according to the present invention;

FIG. 2 is a structural side view showing a first near-eye light field augmented reality (AR) display;

FIG. 3 is a structural side view showing a second near-eye light field AR display;

FIG. 4 is a structural top view showing a third near-eye light field AR display;

FIG. 5 is a sectional side view showing the first near-eye light field AR display;

FIG. 6 is a perspective side view showing the first near-eye light field AR display using a reflection mirror;

FIG. 7 is a perspective side view showing a frame of the first near-eye light field AR display using the reflection mirror;

FIG. 8 is a sectional side view showing the second near-eye light field AR display;

FIG. 9 is a perspective side view showing the second near-eye light field AR display using a reflection mirror;

FIG. 10 is a perspective side view showing a frame of the second near-eye light field AR display using the reflection mirror;

FIG. 11 is a sectional top view showing the third near-eye light field AR display;

FIG. 12 is a sectional top view showing the third near-eye light field AR display using a relay lens; and

FIG. 13 is a sectional top view showing a frame of the third near-eye light field AR display using the relay lens.

### DESCRIPTION OF THE PREFERRED EMBODIMENT

The following description of the preferred embodiment is provided to understand the features and the structures of the present invention.

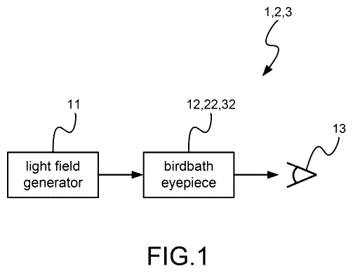

Please refer to FIG. 1 to FIG. 13, which are the structural view showing the preferred embodiment according to the present invention; the structural side view showing the first near-eye light field AR display; the structural side view showing the second near-eye light field AR display; the structural top view showing the third near-eye light field AR display; the sectional side view showing the first near-eye light field AR display; the perspective side view showing the first near-eye light field AR display using the reflection mirror; the perspective side view showing the frame of the first near-eye light field AR display using the reflection mirror; the sectional side view showing the second near-eye light field AR display; the perspective side view showing the second near-eye light field AR display using the reflection mirror; the perspective side view showing the frame of the second near-eye light field AR display using the reflection mirror; the sectional top view showing the third near-eye light field AR display; the sectional top view showing the third near-eye light field AR display using the relay lens; and the sectional top view showing the frame of the third near-eye light field AR display using the relay lens. As shown in the figures, the present invention is a near-eye light field AR display 1,2,3, comprising a light field generator 11 and a birdbath eyepiece 12,22,32.

The light field generator 11 generates a light field as an output.

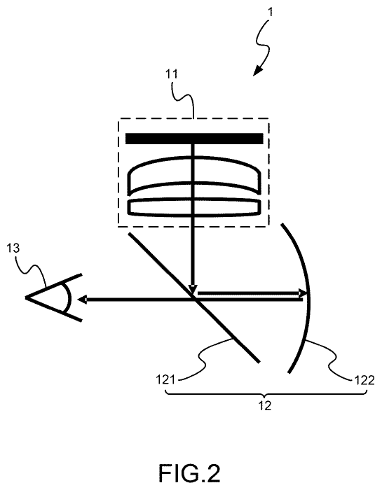

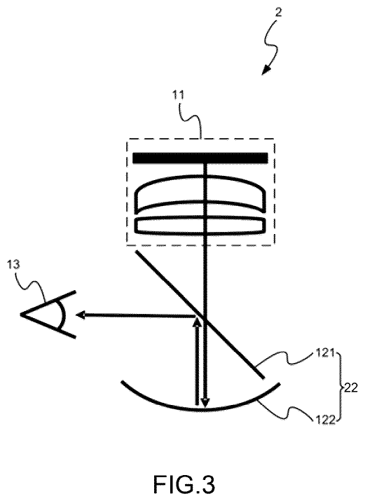

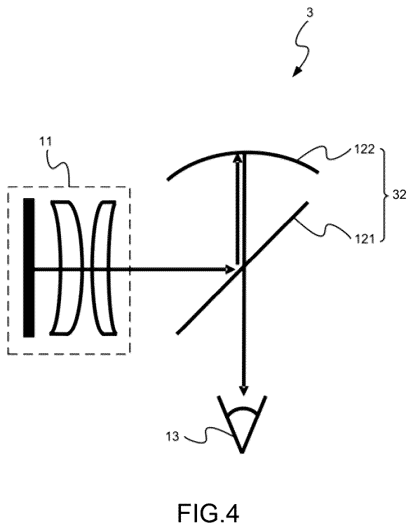

Three states-of-use of the birdbath eyepiece 12,22,32, including a first state-of-use of the birdbath eyepiece 12, a second state-of-use of the birdbath eyepiece 22, and a third state-of-use of the birdbath eyepiece 32, are provided. A first near-eye light field AR display 1 with the first state-of-use of the birdbath eyepiece 12 is shown in FIG. 2; a second near-eye light field AR display 2 with the second state-of-use of the birdbath eyepiece 22 in FIG. 3; and a third near-eye light field AR display 3 with the third state-of-use of the birdbath eyepiece 32 in FIG. 4. Each of the states-of-use of the birdbath eyepiece is an optical unit for reflection and transmission of light; each comprises a beam splitter 121 and a combiner 122 of a curved mirror in various positions and orientations to be combined with the light field generator 11; with the beam splitter 121 as a planar lens and the combiner 122 as a curved mirror, each is connected to the light field generator 11 to receive the light field from the light field generator 11 and project it to human eye 13; and each beam of the light field generated by the light field generator 11 is split into two beams by the beam splitter 121 and one of the two beams is reflected by the combiner 122. In other words, the three states-of-use are configured with the same beam splitter 121 and combiner 122 as the basic elements but the two basic elements are configured in various positions and orientations with respect to the light field generator 11 and the human eye 13.

Thus, a novel near-eye light field AR display 1,2,3 is obtained.

On using the present invention, a light field generator 11, comprising a light source, a projection lens-array unit, and a fusion lens unit, is used. Therein, the light source generates a light field having a plurality of sub-light-fields collectively representing the beams of light that would be originated from virtual objects as if they were real objects in a scene and each of the sub-light-fields is an angular subset of the light field; the sub-light-fields emitted from the light source are converged behind the common aperture; a real image of the virtual objects is formed with the sub-light-fields passing through the projecting lens-array unit; the light source can be a laser beam scanner; a scanning area of the laser beam scanner is divided into a plurality of sub-areas; and each of the sub-areas generates one of the sub-light-fields representing an angular subset of the light field. Nevertheless, the light source can be a micro-display, where the panel of the micro-display is divided into a plurality of sub-areas and each of the sub-areas generates one of the sub-light-fields representing an angular subset of the light field.

In a preferred embodiment, the light field generator 11 emits the light field from an emitting surface (not shown in the figures) of the light field generator 11, where the emitting surface is divided into a plurality of sub-areas to form a plurality of sub-light-fields. Beams of light emitted from the same position of every one of the sub-areas are converged at a common point and all common points for all positions are combined to form a fusion plane 14, and a light field is thus generated. Therein, each beam of the light field is defined by four coordinates in which are two angular coordinates describing direction and two spatial coordinates describing position; a combiner 122 of a birdbath eyepiece 12,22,32 has parameters optimized to maintain angular relations between the beams having the same spatial coordinates but different angular coordinates emitted from the different emitting sub-areas; a structure of the light field is maintained by the birdbath eyepiece 12,22,32 with the angular relations of the beams of the light field having the same spatial coordinates but different angular coordinates maintained on passing through the birdbath eyepiece 12,22,32; the beams emitted from a point of any of the sub-areas and reflected by the combiner 122 have a total width not bigger than the size of the pupil of human eye 13 on passing through the pupil; and the entry pupil diameter of the birdbath eyepiece 12,22,32 is not smaller than the cross-section of the light field at the fusion plane 14.

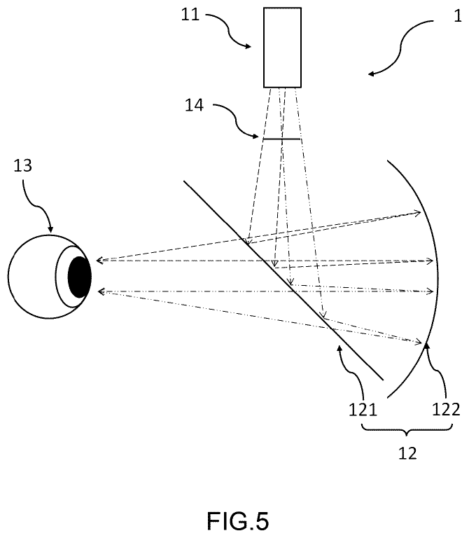

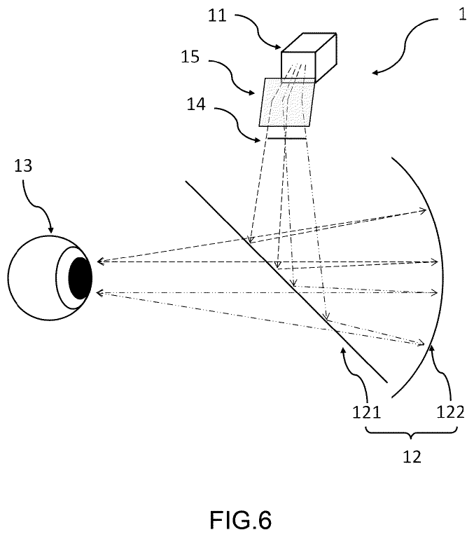

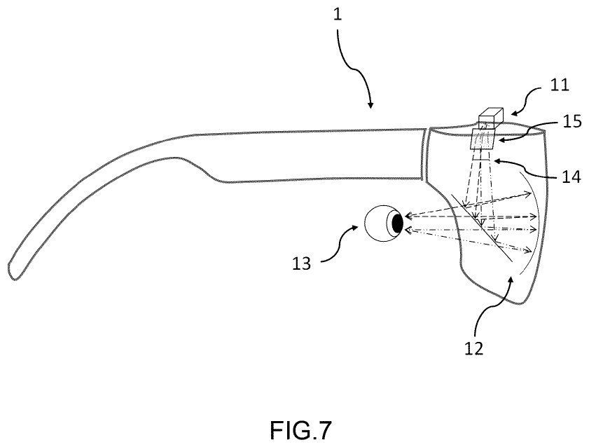

In a first near-eye light field AR display 1 shown in FIG. 5-FIG. 7, the light field generator 11 is placed above the first state-of-use of the birdbath eyepiece 12; and the combiner 122 is placed in front of the human eye 13. The light field is projected from above by the light field generator 11 and received by the birdbath eyepiece 12. The beams of the light field projected from above are split by a beam splitter 121 of the birdbath eyepiece 12 with split beams reflected by the combiner 122, and then projected to the human eye 13. Thus, the first near-eye light field AR display 1 with the birdbath eyepiece 12 is obtained. In FIG. 6 and FIG. 7, the light field generator 11 is placed horizontally right up in front of the human eye 13 in the first near-eye light field AR display 1 with a reflection mirror 15 further inserted in the optical path between the light field generator 11 and the birdbath eyepiece 12 to bend the direction of the beams and improve the overall form factor of the first near-eye light field AR display 1 without loss of light efficiency.

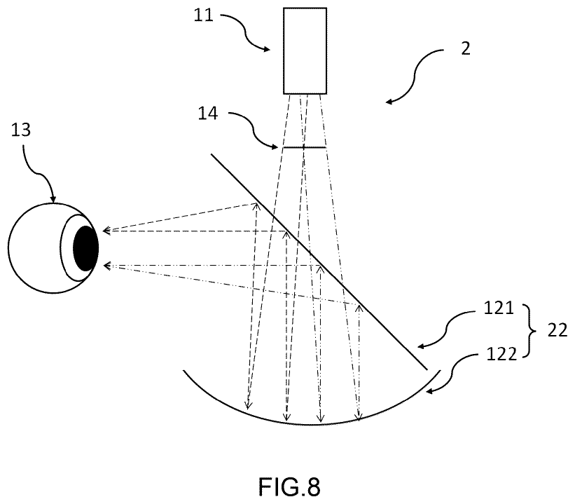

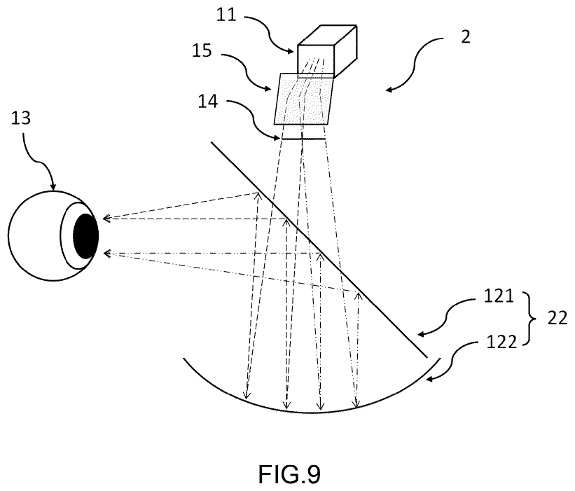

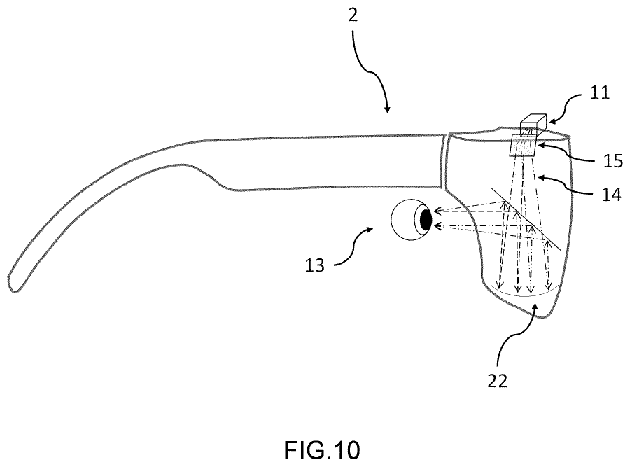

In a second near-eye light field AR display 2 shown in FIG. 8-FIG. 10, the light field generator 11 is placed above the second state-of-use of the birdbath eyepiece 22; and the combiner 122 is placed below the human eye 13. The light field is projected from above by the light field generator 11 and received by the birdbath eyepiece 22. The beams of the light field projected from above are split by the beam splitter 121 with split beams reflected by the combiner 122, and then projected to the human eye 13. Thus, the second near-eye light field AR display 2 with the birdbath eyepiece 22 is obtained. In FIG. 9 and FIG. 10, the light field generator 11 is placed horizontally right up in front of the human eye 13 in the second near-eye light field AR display 2 with the reflection mirror 15 further inserted in the optical path between the light field generator 11 and the birdbath eyepiece 22 to bend the direction of the beams and improve the overall form factor of the second near-eye light field AR display 2 without loss of light efficiency.

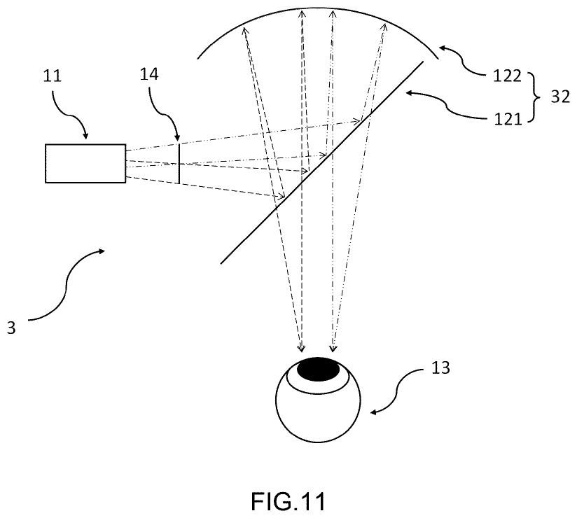

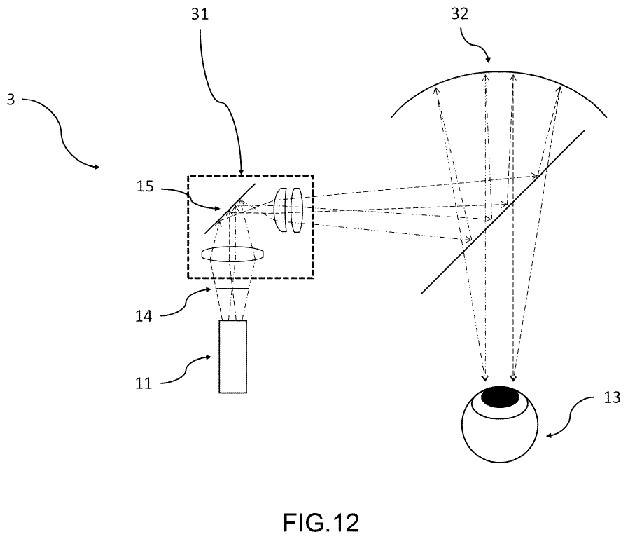

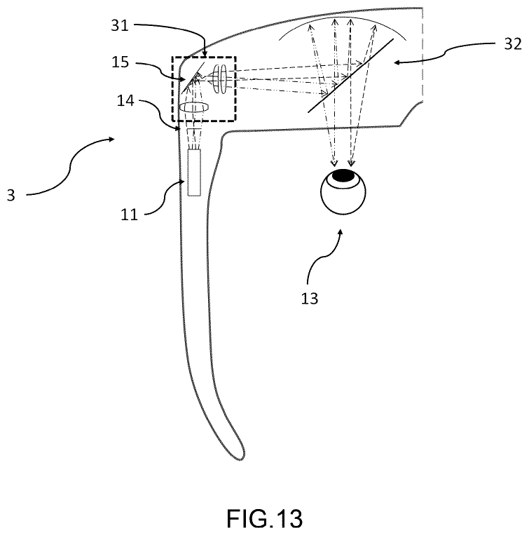

In a third near-eye light field AR display 3 shown in FIG. 11-FIG. 13, the light field generator 11 is placed at a side of a spectacle along a frame of the third near-eye light field AR display 3 with the third state-of-use of the birdbath eyepiece 32; and the combiner 122 is placed in front of the human eye 13. The light field is projected from the side by the light field generator 11 and received by the birdbath eyepiece 32. The beams of the light field projected from the side are split by the beam splitter 121 with split beams reflected by the combiner 122, and then projected to the human eye 13. Thus, the third near-eye light field AR display 3 with the birdbath eyepiece 32 is obtained. In FIG. 12 and FIG. 13, the light field generator 11 is placed at the side of the spectacle along the frame of the third near-eye light field AR display 3 with the reflection mirror 15 further inserted in the optical path between the light field generator 11 and the birdbath eyepiece 32 to bend the direction of the beams and improve the overall form factor of the third near-eye light field AR display 3 without loss of light efficiency.

Nonetheless, as shown in FIG. 12 and FIG. 13, a relay lens 31 is inserted in the optical path between the light field generator 11 and the third state-of-use of the birdbath eyepiece 32. Such a configuration can be applied to every one of the first, second, and third near-eye light field AR displays 1,2,3 to extend the optical path with field of view (FOV) expanded. A reflection mirror 15 can also be integrated in the relay lens 31 to bend the direction of beams and improve the overall form factor of the near-eye light field AR display 1,2,3. The distance between the beam splitter 121 and the relay lens 31 can be extended to 25 millimeters (mm) to 40 mm to avoid the relay lens 31 from blocking eyesight. The fusion plane 14 of the light field can be extended by the relay lens 31 to fully receive the light field generated by the light field generator 11; the entry pupil diameter of the birdbath eyepiece 12,22,32 is not smaller than the cross-section of the light field at the fusion plane 14 extended by the relay lens 31; and the focal length of the combiner 122 is not smaller than the distance along the optical path between the combiner 122 and the fusion plane 14 extended by the relay lens 31.

Hence, the functions of the birdbath eyepiece 12,22,32 provided in the present invention and the methods for achieving the functions are as follows:

1. The parameters of the combiner 122 are optimized to maintain the angular relations between the beams emitted from the different emitting sub-areas of the light field generator 11 having the same spatial coordinates but different angular coordinates. That is, the combiner 122 of the birdbath eyepiece 12,22,32 allows the beams having the same spatial coordinates but different angular coordinates to maintain their angular relations on reaching the retina of the human eye 13 after passing through the birdbath eyepiece 12,22,32 and the pupil of the human eye 13.

2. The beams emitted from a point of any of the emitting sub-areas of the light field generator 11 and reflected by the combiner 122 have a total width not bigger than the size of the pupil of the human eye 13 on passing through the pupil for obtaining a depth of field (DOF) of at least 2 diopters.

3. At the entry pupil of the birdbath eyepiece 12,22,32, the entry pupil diameter is not smaller than the cross-section of the light field at the fusion plane 14 emitted from the light field generator 11, or at the fusion plane 14 of the light field extended by the relay lens 31, to fully receive the light field by the birdbath eyepiece 12,22,32.

4. The focal length of the combiner 122 is not smaller than the distance along the optical path between the combiner 122 and the fusion plane 14 as an imaging plane of the light field, or between the combiner 122 and the fusion plane 14 extended by the relay lens 31. Thus, the birdbath eyepiece 12,22,32 keeps the structure of the light field perceived by the human eye 13 while a low f-number (or focal ratio) is obtained with the focal length becoming bigger.

To sum up, the present invention is a near-eye light field AR display, where a birdbath eyepiece having three states-of-use is adopted in a near-eye light field AR display to project light field to human eye; and the bird-bath eyepiece achieves a low f-number and a large eyebox to effectively expand FOV and increase the volume of space within which the human eye can receive the light field.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A near-eye light field augmented reality (AR) display, comprising
a light field generator, generating a light field as an output; and
a birdbath eyepiece, connecting to said light field generator to receive said light field from said light field generator and projecting said light field to human eye, wherein said birdbath eyepiece comprises a beam splitter and a combiner; and each beam of said light field is split into two beams by said beam splitter with one of said two beams reflected by said combiner.

2. The display according to claim 1,
wherein said combiner has parameters optimized to maintain angular relations between said beams emitted from different emitting sub-areas of said light field generator having the same spatial coordinates but different angular coordinates; and
wherein said birdbath eyepiece maintains a structure of said light field as said beams of said light field with the same spatial coordinates but different angular coordinates maintain angular relations thereof on passing through said birdbath eyepiece to reach retina of said human eye.

3. The display according to claim 1,
wherein said birdbath eyepiece has a plurality of positions and orientations of said beam splitter and said combiner to be combined with said light field generator.

4. The display according to claim 3,
wherein said light field generator is deposed above said birdbath eyepiece; said combiner is deposed in front of human eye; a light field generated by said light field generator from above is received by said birdbath eyepiece; and beams of said light field projected from above are split by said beam splitter with split beams reflected by said combiner, and then projected to said human eye.

5. The display according to claim 3,
wherein said light field generator is deposed above said birdbath eyepiece; said combiner is deposed below human eye; a light field generated by said light field generator from above is received by said birdbath eyepiece; and beams of said light field projected from above are split by said beam splitter with split beams reflected by said combiner, and then projected to said human eye.

6. The display according to claim 3,
wherein said light field generator is deposed at a side of a spectacle along a frame of the display; said combiner is deposed in front of human eye; and a light field generated by said light field generator from said side of said birdbath eyepiece is received by said birdbath eyepiece; and said beams of said light field projected from said side of said birdbath eyepiece are split by said beam splitter with split beams reflected by said combiner, and then projected to said human eye.

7. The display according to claim 1,
wherein said beams emitted from a point of any of said emitting sub-areas of said light field generator and reflected by said combiner have a total width not bigger than the size of a pupil of said human eye when said beams pass through said pupil.

8. The display according to claim 1,
wherein a relay lens is deposed in an optical path between said light field generator and said birdbath eyepiece to extend said optical path with field of view (FOV) expanded.

9. The display according to claim 8,
wherein a distance between a beam splitter of said birdbath eyepiece and said relay lens is extended to be 25 millimeters (mm) to 40 mm.

10. The display according to claim 8,
wherein said light field generator projects a fusion plane as an imaging plane of said light field extended by said relay lens,
wherein the focal length of a combiner in said birdbath eyepiece is not smaller than the distance between said extended fusion plane and said combiner along said optical path.

11. The display according to claim 10,
wherein the entry pupil diameter of said birdbath eyepiece is not smaller than the cross-section of said light field at said fusion plane to fully receive said light field generated by said light field generator.

12. The display according to claim 1,
wherein said birdbath eyepiece has a depth of field (DOF) of at least 2 diopters.

13. The display according to claim 1,
wherein said beam splitter is a planar lens.

14. The display according to claim 1,
wherein said combiner is a curved mirror.

15. The display according to claim 1,
wherein a reflection mirror is deposed in an optical path between said light field generator and said birdbath eyepiece to bend said optical path.
